(19) United States
(12) Patent Application Publication
(10) Pub. No.: US 2017/0247282 A1
(43) Pub. Date: Aug. 31, 2017

(54) GUSSETED ROTARY SPINNERS FOR PRODUCING FIBER FROM MOLTEN MATERIAL

(71) Applicant: Knauf Insulation Inc., Shelbyville, IN (US)

(72) Inventors: Robert W. Zembrodt, Indianapolis, IN (US); Walter A. Johnson, Columbus, IN (US); Paul Wlodarczyk, Indianapolis, IN (US)

(21) Appl. No.: 15/502,127

(22) PCT Filed: Aug. 6, 2015
(86) PCT No.: PCT/US15/43923

§ 371 Date: Feb. 6, 2017

Related U.S. Application Data
(63) Continuation of application No. 14/453,898, filed on Aug. 7, 2014.

(51) Int. Cl. C03B 37/04

(52) U.S. Cl. CPC C03B 37/045; C03B 37/047; D01D 5/18

(57) ABSTRACT

Rotary spinner apparatuses, systems and methods for producing fibers from molten materials are disclosed. Certain exemplary embodiments include substantially net shape single pattern rotary spinner castings that include gussets extending radially inward from a side wall and axially upward form a lower wall to an upper wall. A dispenser may be structured to supply molten material in a downward direction through a hollow interior of the casting to the lower wall. A plenum may be structured to direct elevated temperature glass toward an exterior surface of the casting.

### BACKGROUND

The present application relates generally to rotary spinner apparatuses, systems and methods for producing fibers from molten materials, and more particularly but not exclusively to gusseted rotary spinners for the same. Rotary spinners are useful for producing fiber materials such as fiberglass, glass wool, rock wool, mineral wool, or mixtures thereof. The production process for such materials may include introducing molten glass, rock, minerals, slag and/or other thermoplastic compositions into a rotating spinner, passing the molten material through apertures in the spinner, impinging a stream of elevated temperature gas onto material exiting the spinner apertures to further attenuate the material into fibers, adding binder compositions to the gas/fiber stream, and cooling and collecting the resulting fiber material. Spinners utilized in such processes are exposed to harsh operating conditions including mechanical stressing, thermal stressing and corrosion such as hot corrosion or oxidation. The performance and service longevity of spinners is negatively impacted by these conditions. Compounding these difficulties, the materials from which rotary spinners are formed face a trade-off between strength and corrosion resistance such that compositions exhibiting greater strength offer lesser corrosion resistance and vice-versa. Conventional attempts to address these challenges suffer from a number of drawbacks, disadvantages and shortcomings. There remains a significant need for the unique apparatuses, systems and methods disclosed herein.

### DISCLOSURE

For the purposes of clearly, concisely and exactly describing exemplary embodiments of the invention, the manner and process of making and using the same, and to enable the practice, making and use of the same, reference will now be made to certain exemplary embodiments, including those illustrated in the figures, and specific language will be used to describe the same. It shall nevertheless be understood that no limitation of the scope of the invention is thereby created, and that the invention includes and protects such alterations, modifications, and further applications of the exemplary embodiments as would occur to one skilled in the art.

### SUMMARY

Unique rotary spinner apparatuses, systems and methods for producing fibers from molten materials are disclosed. Certain exemplary embodiments include substantially net shape single pattern rotary spinner castings include gussets extending radially inward from a side wall and axially upward form a lower wall to an upper wall. Further embodiments, forms, objects, features, advantages, aspects, and benefits shall become apparent from the following description and drawings.

### BRIEF DESCRIPTION OF THE DRAWINGS

FIG. 1 illustrates an exemplary system for producing fibers from molten material.

FIG. 2 illustrates a side sectional view of an exemplary rotary spinner.

FIG. 3 illustrates a side sectional view of another exemplary rotary spinner.

FIG. 4 illustrates a partial side sectional view the exemplary spinner of FIG. 3.

FIG. 5 illustrates a top view of a hub member of the exemplary spinner of FIG. 3.

FIG. 6 illustrates a bottom view of an annular member of the spinner of FIG. 3.

FIG. 7 illustrates a bottom view of a slinger plate of the exemplary spinner of FIG. 3.

FIG. 8 illustrates a sectional view of another exemplary spinner.

FIG. 9 illustrates a bottom view of a slinger basket of the spinner of FIG. 8.

FIG. 10 illustrates a perspective view of another exemplary annular member.

### DETAILED DESCRIPTION OF ILLUSTRATIVE EMBODIMENTS

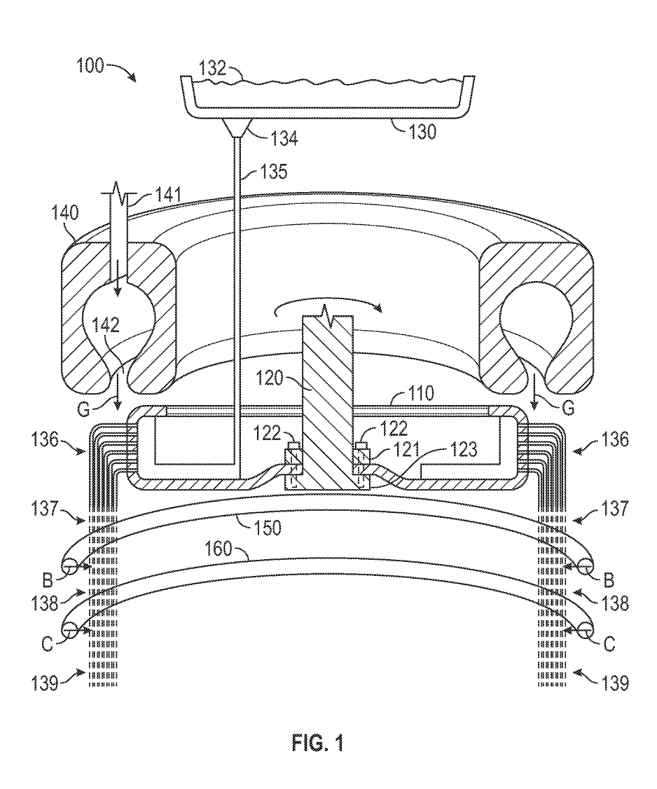

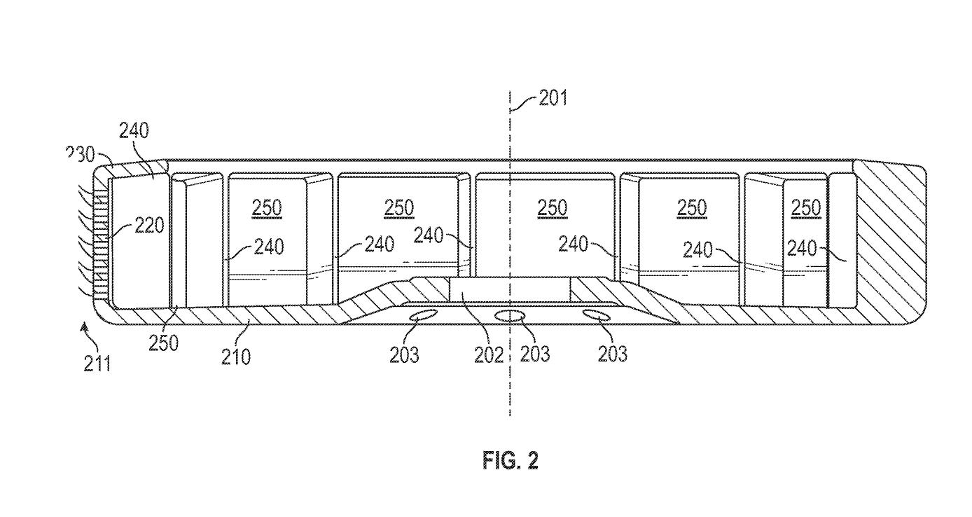

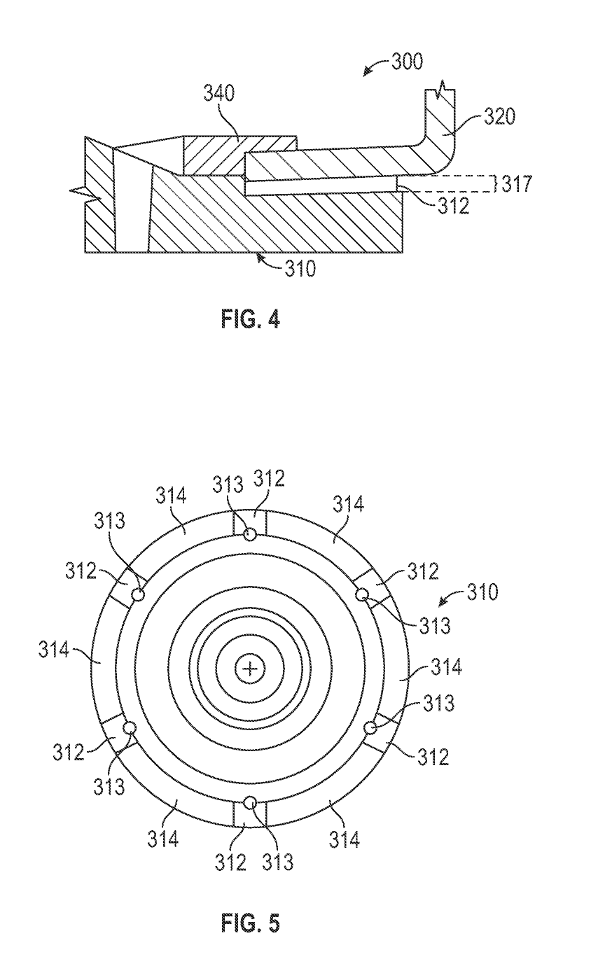

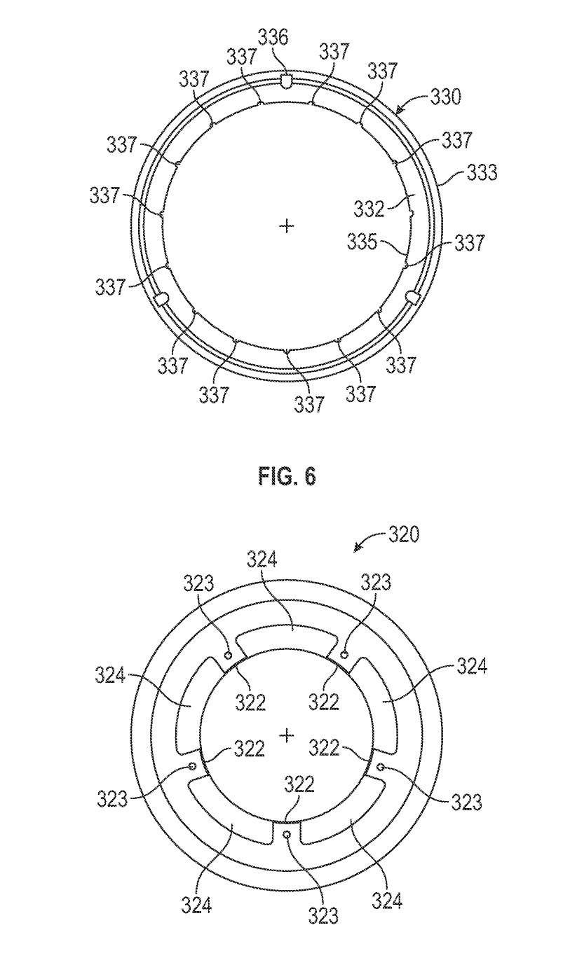

With reference to FIG. 1 there is illustrated an exemplary system 100 for producing fibers from molten material. System 100 includes a spinner 110 which is coupled with a rotating shaft 120. In the illustrated embodiments spinner 110 is coupled with rotating shaft 120 by fastening bolts 122 which pass through apertures in ring member 121, spinner 110, and an upper flange portion 123 of rotating shaft 120 effective to clamp spinner 110 between flange 123 and ring member 121. It shall be appreciated that a variety of other coupling structures may be utilized to couple spinner 110 with rotating shaft 120 including, for example, alternate fastener arrangements, threaded connectors, spline connectors and other types of coupling structures. It shall further be appreciated that spinner 110 may be provided in a number of unique structural forms, exemplary embodiments of which are disclosed herein below in connection with FIGS. 2-9.

System 100 further includes a furnace 130 containing a supply of molten thermoplastic material 132. It shall be appreciated that a variety of molten thermoplastic materials may be utilized including for example glass, rock, other mineral compositions such as slags and basaltic materials, or mixtures thereof. A dispensing device 134 is connected to furnace 130 and dispenses a stream of molten material 135 to spinner 110. As spinner 110 is rotated by rotating shaft 120 centrifugal force acts on molten material 135 and forces it outward toward the side wall of spinner 110 and through a plurality of apertures formed in a side wall of spinner 110.

System 100 further includes a plenum 140 which receives a mixture of air and gas to be combusted from a supply 141 and outputs elevated temperature gas at annular outlet 142. Plenum 140 is structured to direct a stream of elevated temperature gas proximate the outer periphery of spinner 110 generally in the direction indicated by arrows G. Molten material exits the side wall of spinner as a plurality of pre-fibers 136 which encounter the stream of elevated temperature gas provided by plenum 140. The pre-fibers 136 are entrained in the gas stream and are further attenuated into fibers 137. Fibers 137 travel in a downward direction through annular feed ring 150 which introduces a cooling material into the gas stream as generally indicated by arrows B to provide cooled fibers 138 entrained in the gas stream. The fiber/binder mixture 138 travels in a downward direction through annular feed ring 160 which introduces a binder material into the gas stream as generally indicated by arrows C to provide a cooled fiber/binder mixture 139 entrained in the gas stream. The cooled fiber/binder mixture 139 continues to travel in the downward direction where it is collected and may be further processed for forming fiber-based materials such as fiber glass, rock wool, or mineral wool materials and structures composed thereof.

During operation of system 100 the spinner 110 may experience substantial thermal stress. In certain embodiments the high temperature portions of the spinner 110 may be at least 2000 degrees F. In certain embodiments used in connection with molten glass the high temperature portions of the spinner 110 may range from 1700 degrees F. to 2100 degrees F. or various points therebetween. In certain embodiments used in connection with molten slag or molten basaltics the high temperature portions of the spinner 110 may range from 2000 degrees F. to 2300 degrees F. or various points therebetween. In certain embodiments used in connection with molten rock compositions the high temperature portions of the spinner 110 may range from 2100 degrees F. to 2400 degrees F. or various points therebetween. Such high temperature portions may be present in the side wall of the spinner 110 and in particular, though not exclusively, at or near the intersection of the side wall and the lower wall, or at or near the intersection of the side wall and the upper wall or flange proximate the stream of elevated temperature gas directed from the plenum 140. The thermal gradient experienced by the spinner 110 may also be substantial. In certain embodiments the low temperature portions of the spinner 110 may range from 800 degrees F. to 900 degrees F. or various points therebetween. These low temperatures portions may be present in the lower wall or base of spinner 110 in particular, though not exclusively adjacent the coupling with shaft 120. The thermal gradient experienced by the spinner may range from any of the temperatures of the aforementioned high temperature portions to any of the temperatures of the aforementioned low temperature portions. It shall be appreciated that the exemplary temperatures and ranges disclosed herein are non-limiting examples of the thermal conditions which may be experienced by spinner 110. A variety of other temperature conditions may also be experienced, including higher temperatures, lower temperatures, larger temperature gradients and smaller temperature gradients.

With reference to FIG. 2 there is illustrated a spinner 200 which may be provided as one exemplary form of spinner 110 described above in connection with FIG. 1. Spinner 200 includes a base 210 extending radially outward from central axis 201 to a substantially circular periphery 211, a side wall 220 extending about the circular periphery 211 in an axially upward direction from the base 210, and an upper flange 230 extending radially inward from the side wall 220. Spinner 200 further includes a plurality of gussets 240 extending radially inward from the side wall 220 and extending axially from the base 210 to the upper flange 220. It shall be appreciated that in various embodiments, upper flange 220 may extend radially inward past gussets 240, may extend radially inward over only part of the radial distance of gussets 240, or may be substantially co-extensive with the radial and circumferential extent of side wall 220 such that the top of spinner 210 is substantially open.

The interior surfaces of spinner 200 define a plurality of pockets 250 bounded by surfaces of the base 220, the side wall 230, the flange 230, and respective pairs of the plurality of gussets 240. The pockets 250 open inwardly to a central structural void which extends across substantially the entire interior region of spinner 200. A plurality of apertures 270 (only a few of which are depicted for clarity and simplicity of illustration) extend through the portions of the side wall 220 bounding the plurality of pockets 250 and may be formed, for example, by mechanical drilling, laser drilling or other techniques. A central aperture 202 and a plurality of vent holes 203 are formed in spinner 200 and are structured to receive a rotating shaft and associated connection structures, such as those illustrated above in connection with FIG. 1.

In the illustrated embodiment, spinner 200 is structured as a substantially net-shaped single-pattern casting including base 210, side wall 220, upper flange 230, and gussets 240. It shall be appreciated that a substantially net shaped single-pattern casting refers to a casting structure that is formed as a unitary piece through a casting process utilizing a single casting pattern and that may be further processed, for example, to balance the cast structure for subsequent rotation, remove structural artifacts or undesired features of the casting process such as rough surfaces or edges, and to form apertures such as apertures 270 or other types of extrusion apertures as well as fastener apertures. It shall further be appreciated that the term substantially net shape single-pattern casting describes distinctive structural characteristics of the spinner 200.

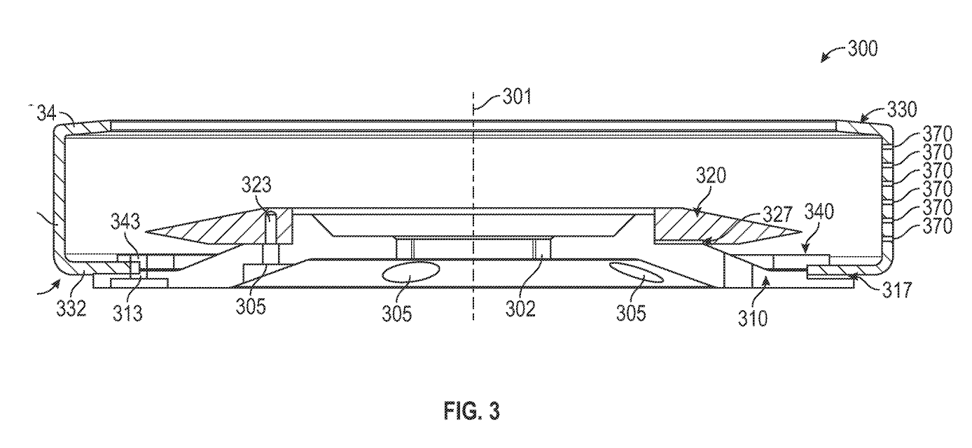

With reference to FIGS. 3-7 there are illustrated several views of a spinner 300 and portions thereof. Spinner 300 is one exemplary form of spinner 110 described above in connection with FIG. 1. Spinner 300 includes a hub 310 extending radially outward relative to a central axis 301, an annular member 330 which overlaps with a portion of hub 310 and extends further radially outward, a slinger 320 positioned above hub 310 and extending radially outward toward annular member 330, and a retaining member 340 positioned above a portion of hub 310 and a portion of annular member 330. It shall be appreciated that hub 310, annular member 330 and retaining member 340 may be positioned in other configurations including, for example, with the annular member 330 positioned below hub 310 and retaining member positioned below hub 310 and annular member 330.

Annular member 330 includes a lower wall 332 extending radially outward, a side wall 333 extending axially upward from the lower wall 332, and an upper wall 334 extending radially inward from the side wall 333. A plurality of apertures 370 (only a few of which are depicted for clarity and simplicity of illustration) are formed in the side wall 333. A first side of the lower wall 332 contacts the hub 310 at a plurality of contact areas 312. Lower wall 332 is spaced apart from the hub 310 at a plurality of gap regions 317 which are provided by recess portions 314 intermediate the plurality of contact areas 312. In the illustrated embodiment contact areas 312 are structured as raised portions of hub 310 which extend upward relative to recess portions 314 of hub 310 and are distributed about the periphery of hub 310. It shall be appreciated that corresponding raised portions and recess portions may be provided in the surface of lower wall 332 of annular member 330 which faces the hub 310 as an alternative to or in addition to providing the contact areas and recess portions of the illustrated embodiment. It shall be further appreciated that the illustrated pattern of raised portions and recess portions is but one non limiting example and that multiple additional forms are contemplated, further non-limiting examples of which shall now be described. It shall also be appreciated that in various embodiments, upper wall 334 may extend radially inward a greater or lesser amount than the illustrated embodiment or be substantially co-extensive with the radial and circumferential extent of side wall 333 such that the top of spinner 310 is substantially open.

In certain additional forms the raised portions and recess portions may be provided in concentric ring patterns including one or more raised ring areas and one or more recessed ring areas. In some forms inner and outer concentric raised areas may be separated by intermediate recessed areas. In some forms the raised ring areas may be continuous. In other forms the raised ring areas may be intermittent or separated. In further forms the raised portions may be post-shaped projections extending above adjacent or surrounding recessed portions. In a further additional example the raised portions may be hemispherical or lobe-shaped projections resembling bumps extending above adjacent or surrounding recessed portions. Additional examples may use different numbers of raised portions and recess portions, differently positioned or differently angled raised portions and recess portions, differently shaped raised portions and recess portions, and/or differently distributed raised portions and recess portions.

Regardless of the particular structural configuration utilized, the raised portions and recess portions of the hub 310 and/or the annular member 330 are structured to provide support of annular member 330 by hub 310 while providing reduced contact surface area between the overlapping portions of the annular member 330 and the hub 310. In exemplary embodiments the reduced contact surface area provides reduced heat transfer from the annular member 330 to the hub 310.

A plurality of fasteners (not illustrated) are inserted through fastener apertures 313 formed in hub 310 and a plurality of apertures 343 formed in retaining member 340 to couple retaining member 340 and hub 310. In an exemplary form the fasteners may be threaded bolts which engage mating threads formed in apertures 343 of retaining member 340. A variety of other fastener structures may also be utilized. In the illustrated embodiment the fasteners also pass through respective ones of recesses 337 formed in the inner periphery 335 of lower wall 332 of annular member 330. In this configuration the fasteners may impart rotational force from the hub to the annular member causing it to rotate with the hub 310 while still allowing the annular member 330 to move relative to hub 310 such as may occur during thermal expansion of the annular member 330.

In the illustrated embodiment the retaining member 340, the hub 310 and the fasteners connecting these two structures are configured to contact overlapping portions of annular member 330 while imparting a substantially zero clamping force on the annular member 330. This configuration accommodates movement of the annular member relative to the hub 310 and the clamping member 340 with predetermined stress transfer characteristics between these structures that are substantially zero over a certain range of expansion where annular member 330 moves freely relative to hub 310 in a radial direction. In other embodiments the retaining member 340, the hub 310 and the fasteners connecting these two structures may be configured to impart a non-zero positive clamping force on the annular member 330. The clamping force may be selected to accommodate varying predetermined degrees of movement with varying predetermined stress transfer characteristics between these structures depending on the requirements of different applications. In further embodiments the retaining member 340 may be spaced apart from the annular member 330 while still fixedly coupled with hub 310 to accommodate even greater movement of annular member 330 relative to hub 310 and retaining member 330.

Slinger 320 contacts the hub 310 at a plurality of contact areas 322 and is spaced apart from the hub 310 at a plurality of gap regions 327 which are provided by recess portions 324 intermediate the plurality of contact areas 322. A plurality of fasteners (not illustrated) may be introduced through fastener apertures 305 of hub 310 and fastener apertures 323 of slinger 320. In an exemplary form the fasteners may be threaded bolts which engage mating threads formed in apertures 323. A variety of other fastener structures may also be utilized.

In the illustrated embodiment contact areas 322 are structured as raised portions of slinger 320 which extend outward relative to recess portions 324 of slinger 320 and are distributed about slinger 320 in the illustrated pattern. It shall be appreciated that corresponding raised portions and recess portions may be provided in the surface hub 310 which faces the slinger 320 as an alternative to or in addition to providing the contact areas and recess portions of the illustrated embodiment. It shall be further appreciated that the illustrated pattern of raised portions and recess portions is but one non limiting example and that multiple additional forms are contemplated. These additional forms may include structures which are the same as or similar to the further non-limiting examples described above in connection with the raised and recessed portions of the interface between the hub 310 and the annular member 330.

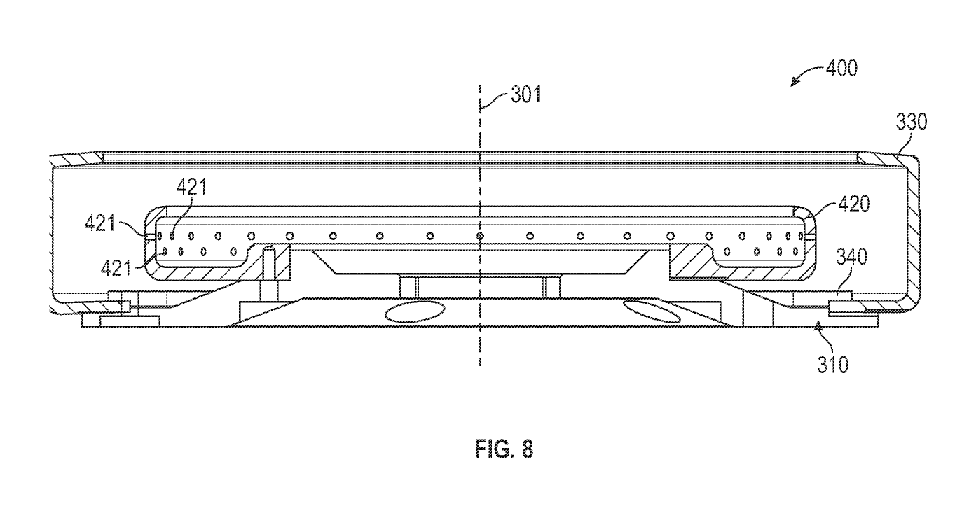

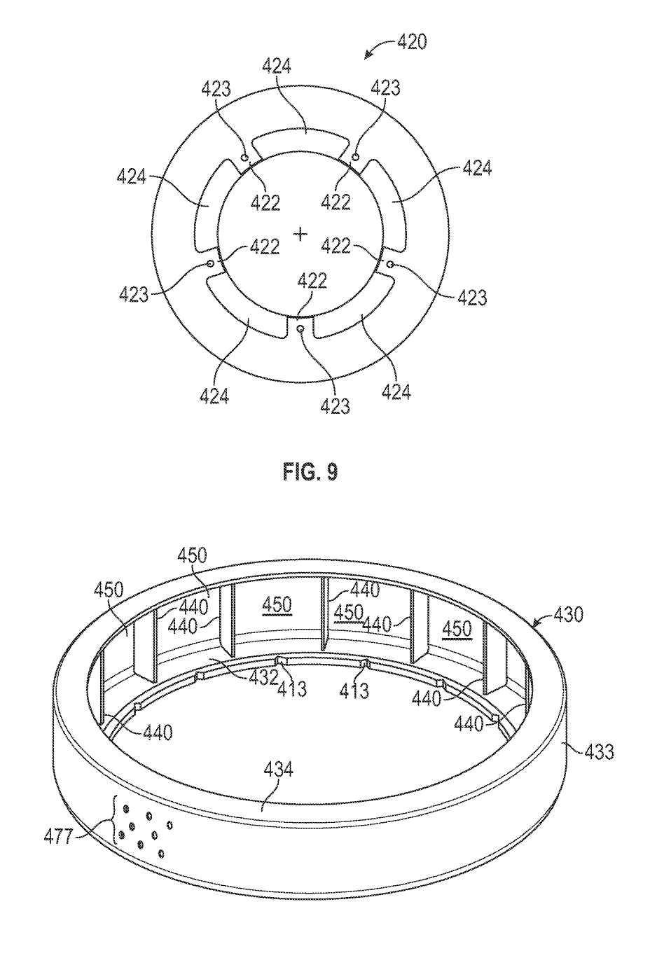

With reference to FIGS. 8 and 9 there are illustrated several views of a spinner 400 and portions thereof. Spinner 400 is one exemplary form of spinner 110 described above in connection with FIG. 1. Spinner 400 includes a hub 310 extending radially outward relative to a central axis 301, an annular member 330 which overlaps with a portion of hub 310 and extends further radially outward, and a retaining member 340 positioned above a portion of hub 310 and a portion of annular member 330. Further details of these structures are described above in connection with the slinger 300 illustrated in FIGS. 3-7. Spinner 400 further includes a cup shaped slinger 420 including a plurality of holes 421 in its side wall positioned above hub 310 and extending radially outward toward annular member 330.

Slinger 420 contacts the hub 310 at a plurality of contact areas 422 and is spaced apart from the hub 310 at a plurality of gap regions which are provided by recess portions 424 intermediate the plurality of contact areas 422. In the illustrated embodiment contact areas 422 are structured as raised portions of slinger 420 which extend outward relative to recess portions 424 of slinger 420 and are distributed about slinger 420 in the illustrated pattern. It shall be appreciated that corresponding raised portions and recess portions may be provided in the surface hub 310 which faces the slinger 420 as alternative to or in addition to providing the contact areas and recess portions of the illustrated embodiment. It shall be further appreciated that the illustrated pattern of raised portions and recess portions is but one non limiting example and that multiple additional forms are contemplated. These additional forms may include structures which are the same as or similar to the further non-limiting examples described above in connection with the raised and recessed portions of the interface between the hub 310 and the annular member 330 of slinger 300.

With reference to FIG. 10 there is illustrated an additional annular member 430 which may be utilized connection with spinner 300 or spinner 400 in place of annular member 330. Annular member 430 includes a lower wall 432 extending radially outward, a side wall 433 extending axially upward from the lower wall 432, and an upper wall 434 extending radially inward from the side wall 433. The interior surfaces of annular member 430 define a plurality of pockets 450 bounded by surfaces of the lower wall 432, the side wall 433, the upper wall 434, and respective pairs of the plurality of gussets 440. The pockets 450 open inwardly. A plurality of apertures 477 (only a few of which are depicted for clarity of illustration) extend through the portions of the side wall 433 bounding the plurality of pockets 550 and may be formed, for example, by mechanical drilling, laser drilling or other techniques. Annular member 430 also includes a plurality of recesses 413 which may be structured and function similar to recesses 313 described above in connection with spinner 300. It shall be appreciated that in various embodiments, upper wall 434 may extend radially inward a greater or lesser amount than the illustrated embodiment or be substantially co-extensive with the radial and circumferential extent of side wall 433 such that the top of spinner 410 is substantially open.

In the illustrated embodiment, spinner 200 is structured as a substantially net-shaped single-pattern casting including lower wall 432, side wall 433, upper wall 434, and gussets 440. As noted above, it shall be appreciated that a substantially net shaped single-pattern casting refers to a cast structure that is formed as a unitary piece through a casting process utilizing a single casting pattern and that may be further processed, for example, to balance the cast structure for subsequent rotation, remove structural artifacts of the casting process such as rough surfaces or edges, and form apertures such as extrusion apertures and fastener apertures. It shall further be appreciated that the term substantially net shape single-pattern casting describes distinctive structural characteristics of the annular member 430.

It shall be appreciated that the apparatuses, systems and methods disclosed herein permit the formation of rotary spinner structures from existing alloys previously found to offer inadequate performance and/or inadequate durability under certain operation conditions such as those disclosed herein. Such exemplary alloy materials include a number of steel alloys as well as Co-based, Fe-based, Cr-based, and Ni-based superalloys including for example FSX-414, HS-21, X-45, F-75, and IN-625. Such alloys may be utilized to form structures such as spinner 200, annular member 330, annular member 430, slinger 320 and slinger 420 among other structures. It shall be appreciated that the foregoing and similar materials exhibit creep or elevated tensile strength that makes them undesirable or unsuited for temperature operation above about 2000 degrees F.

A number of non-limiting exemplary embodiments and forms shall now be further described. Certain exemplary embodiments include a centrifugal spinner apparatus for producing fibers from molten material comprising a substantially net-shaped single-pattern casting including a base extending radially outward to a substantially circular periphery extending about a central axis line, a side wall extending about the circular periphery in an axially upward direction from the base, an upper flange extending radially inward from the side wall, and a plurality of gussets extending radially inward from the side wall and extending axially from the base to the upper flange, the casting defines a plurality of pockets bounded by surfaces of the base, the side wall, the flange, and respective pairs of the plurality of gussets and opening inwardly to a central structural void, and a plurality of holes are formed through portions of the side wall bounding the plurality of pockets.

The exemplary embodiments including a centrifugal spinner apparatus may be provided in a plurality of forms. Certain forms further comprise a shaft extending along and rotatable about the central axis line, the shaft being coupled with the base and extending from a side of the base opposite the central structural void. In certain forms the shaft is coupled with the base by first and second clamping members and wherein the first clamping member contacts the upper surface of the base. Certain forms further comprise a dispenser structured to direct a stream of molten material in a downward direction through the central structural void to the base. Certain forms further comprise a plenum structured to direct a stream of elevated temperature gas toward an exterior surface of the side wall in a direction generally parallel to the side wall. In certain forms the plurality of gussets comprise an odd number of gussets. In certain forms the radially inward edges of the gussets are substantially perpendicular to the base. In certain forms the casting is formed of an alloy selected from the group consisting of FSX-414, HS-21, X-45, F-75, and IN-625.

Certain exemplary embodiments include a method comprising producing a net-shaped casting from a single wax pattern, the casting including a lower wall extending in a radial direction to a substantially circular circumference, a side wall extending in an axial direction from the lower wall, an upper flange extending in a radially inward direction from the side wall, and a plurality of gussets extending in a radially inward direction from the side wall and in an axially upward direction from the lower wall to the upper flange, forming a plurality of holes through the side wall of the casting, attaching the casting to a rotatable member, and introducing molten material into the central void of the casting while rotating the casting with the rotating member effective to cause the molten material to flow through the plurality of holes to produce a plurality of fibers.

The exemplary embodiments including a method may be provided in a plurality of forms. In certain forms the lower wall of the casting contacts a portion of the rotatable member. In certain forms the molten material is introduced to a central structural void of the casting by a dispenser positioned on a side of the casting opposite the lower wall. Certain forms further comprise attaching the casting to the rotatable member with fastening members that contact the upper surface of the lower wall of the casting. Certain forms further comprise directing a stream of elevated temperature gas at the exterior surface of the side wall of the casting. In certain forms the stream of elevated temperature gas flows in a direction generally parallel to the side wall of the casting. In certain forms a first portion of the casting is heated to a temperature of at least 2000 degrees F. by at least one of the stream of elevated temperature gas and the molten material. In certain forms the first portion of the casting is located in the side wall. In certain forms the first portion of the casting is located at the intersection of the side wall and the upper flange. In certain forms a second portion of the casting is heated to a temperature of at most 900 degrees F. by at least one of the stream of elevated temperature gas and the molten material. In certain forms the second portion of the casting is located in the lower wall.

Certain exemplary embodiments include a system comprising, a shaft extending along and being rotatable about an axis, a spinner having a lower wall extending outwardly relative to the axis, a side wall extending upwardly from the lower wall, an upper wall extending inwardly from the side wall, and a plurality of gussets extending inwardly from the side wall and extending upwardly from the lower wall to the upper wall, a plurality of extrusion holes being defined in the side wall, the lower wall being coupled with the shaft, the spinner defining a plurality of pockets bounded by surfaces of the lower wall, the side wall, the upper wall, and respective pairs of the plurality of gussets and opening inwardly to a hollow interior, a dispenser structured to supply molten material in a downward direction through the hollow interior to the lower wall, and a plenum structured to direct elevated temperature glass toward an exterior surface of the spinner.

The exemplary embodiments including a system may be provided in a plurality of forms. In certain forms the plurality of gussets comprise at least six gussets. In certain forms the gussets are substantially perpendicular to the lower wall. In certain forms the spinner comprises a substantially net-shaped casting. In certain forms the casting is a single pattern casting. In certain forms the casting consists essentially of one of a Co-based alloy and a Ni-based alloy. In certain forms the casting is formed of an alloy selected from the group consisting of FSX-414, HS-21, X-45, F-75, and IN-625. In certain forms a plurality of extrusion holes are formed by drilling into the casting.

While the invention has been illustrated and described in detail in the drawings and foregoing description, the same is to be considered as illustrative and not restrictive in character, it being understood that only certain exemplary embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A centrifugal spinner apparatus for producing fibers from molten material comprising:
a substantially net-shaped single-pattern casting including a base extending radially outward to a substantially circular periphery extending about a central axis line, a side wall extending about the circular periphery in an axially upward direction from the base, an upper flange extending radially inward from the side wall, and a plurality of gussets extending radially inward from the side wall and extending axially from the base to the upper flange;
wherein the casting defines a plurality of pockets bounded by surfaces of the base, the side wall, the flange, and respective pairs of the plurality of gussets and opening inwardly to a central structural void, and a plurality of holes are formed through portions of the side wall bounding the plurality of pockets.

2. The centrifugal spinner apparatus of claim 1 further comprising a shaft extending along and rotatable about the central axis line, the shaft being coupled with the base and extending from a side of the base opposite the central structural void.

3. The centrifugal spinner apparatus of claim 2 wherein the shaft is coupled with the base by first and second clamping members and wherein the first clamping member contacts the upper surface of the base.

4. The centrifugal spinner apparatus of claim 1 further comprising a dispenser structured to direct a stream of molten material in a downward direction through the central structural void to the base.

5. The centrifugal spinner apparatus of claim 1 further comprising a plenum structured to direct a stream of elevated temperature gas toward an exterior surface of the side wall in a direction generally parallel to the side wall.

6. The centrifugal spinner apparatus of claim 1 wherein the plurality of gussets comprise an odd number of gussets.

7. The centrifugal spinner apparatus of wherein the radially inward edges of the gussets are substantially perpendicular to the base.

8. The centrifugal spinner apparatus of claim 1 wherein the casting is formed of an alloy selected from the group consisting of FSX-414, HS-21, X-45, F-75, and IN-625.

9. A method comprising:
producing a net-shaped casting from a single wax pattern, the casting including a lower wall extending in a radial direction to a substantially circular circumference, a side wall extending in an axial direction from the lower wall, an upper flange extending in a radially inward direction from the side wall, and a plurality of gussets extending in a radially inward direction from the side wall and in an axially upward direction from the lower wall to the upper flange;
forming a plurality of holes through the side wall of the casting;
attaching the casting to a rotatable member; and
introducing molten material into the central void of the casting while rotating the casting with the rotating member effective to cause the molten material to flow through the plurality of holes to produce a plurality of fibers.

10. The method of claim 9 wherein the lower wall of the casting contacts a portion of the rotatable member.

11. The method of claim 9 wherein the molten material is introduced to a central structural void of the casting by a dispenser positioned on a side of the casting opposite the lower wall.

12. The method of claim 9 further comprising attaching the casting to the rotatable member with fastening members that contact the upper surface of the lower wall of the casting.

13. The method of any of claim 9 further comprising directing a stream of elevated temperature gas at the exterior surface of the side wall of the casting.

14. The method of claim 13 wherein the stream of elevated temperature gas flows in a direction generally parallel to the side wall of the casting.

15. The method of claim 14 wherein a first portion of the casting is heated to a temperature of at least 2000 degrees F. by at least one of the stream of elevated temperature gas and the molten material.

16. The method of claim 15 wherein the first portion of the casting is located in the side wall.

17. The method of claim 15 wherein the first portion of the casting is located at the intersection of the side wall and the upper flange.

18. The method of claim 15 wherein a second portion of the casting is heated to a temperature of at most 900 degrees F. by at least one of the stream of elevated temperature gas and the molten material.

19. The method of claim 18 wherein the second portion of the casting is located in the lower wall.

20. A system comprising:
a shaft extending along and being rotatable about an axis;
a spinner having a lower wall extending outwardly relative to the axis, a side wall extending upwardly from the lower wall, an upper wall extending inwardly from the side wall, and a plurality of gussets extending inwardly from the side wall and extending upwardly from the lower wall to the upper wall, a plurality of extrusion holes being defined in the side wall, the lower wall being coupled with the shaft, the spinner defining a plurality of pockets bounded by surfaces of the lower wall, the side wall, the upper wall, and respective pairs of the plurality of gussets and opening inwardly to a hollow interior;
a dispenser structured to supply molten material in a downward direction through the hollow interior to the lower wall; and
a plenum structured to direct elevated temperature glass toward an exterior surface of the spinner.

21. (canceled)

22. (canceled)

23. (canceled)

24. (canceled)

25. (canceled)

26. (canceled)

27. (canceled)
